(19) United States
(12) Patent Application Publication
(10) Pub. No.: US 2007/0246086 A1
(43) Pub. Date: Oct. 25, 2007

(54) Circuit board cleaning apparatus, burn-in board cleaning apparatus, methods of cleaning a circuit board, and methods of cleaning a burn-in board

(75) Inventors: Ong Eng Guan, (US); Tao Yo Chang, (US); Ng Swee Lye, (US)

Correspondence Address: WELLS ST. JOHN P.S., 601 W. FIRST AVENUE, SUITE 1300, SPOKANE, WA, 99201, US

(73) Assignee: Micron Technology, Inc.

(21) Appl. No.: 11/453,426

(22) Filed: Jun. 14, 2006

(30) Foreign Application Priority Data
Apr. 24, 2006 (SG) 200602791-6

(51) Int. Cl. B08B 3/00

(52) U.S. Cl. 134/103.2; 134/198

(57) ABSTRACT

This invention includes a circuit board cleaning apparatus comprising a circuit board support structure configured to receive a circuit board for cleaning. A plurality of spray openings is oriented to spray cleaning fluid onto said circuit board as received by the support structure. The spray openings are mounted above the support structure for movement relative to the support structure across the circuit board during cleaning of the circuit board. Additional and/or other apparatus are disclosed, as are inventive methods using such apparatus and other apparatus.

### TECHNICAL FIELD

This invention relates to circuit board cleaning apparatus, to burn-in board cleaning apparatus, to methods of cleaning a circuit board, and to methods of cleaning burn-in boards.

### BACKGROUND OF THE INVENTION

A plurality of integrated circuits is typically fabricated onto a substrate, such as a semiconductor wafer. Ultimately, individual integrated circuit chips are typically cut or diced from the wafer or other substrate. In many instances, the diced chips are packaged, for example with a conductive lead frame, wire bonded and subsequently molded or encapsulated into a desired profile. Integrated circuit packages of these and other constructions are ultimately typically surface mounted to a suitable circuit board which typically will constitute a component of a larger system. In the context of this document, a “circuit board” is any substrate having some circuitry fabricated therein or thereon, and to which an integrated circuit chip or package is temporarily or permanently electrically connected.

Integrated circuit chips upon packaging are typically subjected to what is commonly referred to as burn-in. Burn-in is an electrical stress test that employs voltage and temperature to accelerate the potential failure of a device. Burn-in essentially simulates the operating life of a device with the electrical excitation applied during burn-in intended to mirror the worst case bias that the device will be subjected to in the course of its usable life. Depending on the burn-in duration, the information obtained may pertain to the device's early life failure or its wear-out. Burn-in may be used as a reliability monitor or as a production screen to weed out potential infant mortalities.

Burn-in is typically facilitated by using burn-in boards where the integrated circuit packages are temporarily received. Burn-in boards are circuit boards which typically contain a plurality of rows of sockets which temporarily receive the integrated circuit packages undergoing burn-in. One or more burn-in boards with integrated circuit packages received by the sockets are placed within a suitable oven and electrically connected to a suitable system which applies electrical stress to the integrated circuits received by the sockets. Burn-in is typically conducted at about 125° C. for some suitable period of time with the performance of the individual integrated circuit packages monitored for acceptable or failed results. The burn-in board is then removed from the oven and the integrated circuit packages removed from the sockets.

The burn-in sockets, of course, include metal contacts. These and other areas of the sockets can become contaminated with solder or other material after a period of use, and thereby require cleaning. Burn-in board cleaning can be conducted in a number of manners which might be classified as dry or wet cleaning. Exemplary prior art dry cleaning techniques include mechanical brushing, use of abrasive cleaning pads, and plasma cleaning. Prior art cleaning has included spraying with a liquid or mixture of gas and liquid, for example by spraying or dipping a burn-in board into a bath of a suitable chemical cleaning solution. Following cleaning with a chemical solution, the burn-in boards are desirably subsequently cleaned with a rinsing fluid predominately comprising or consisting of water.

The invention was principally motivated in facilitating the rinsing of burn-in boards with an aqueous cleaning fluid (i.e., de-ionized water, reverse osmosis water, etc.) subsequent to a chemical cleaning. However, the invention in its broadest aspects is in no way so limited, and includes apparatus and methods for cleaning any circuit board (whether existing or yet-to-be developed) using any cleaning fluid.

### BRIEF DESCRIPTION OF THE DRAWINGS

Preferred embodiments of the invention are described below with reference to the following accompanying drawings.

FIG. 1 is a diagrammatic plan view of a portion of a circuit board cleaning apparatus in accordance with an aspect of the invention.

FIG. 2 is a diagrammatic side view of the FIG. 1 apparatus.

FIG. 3 is like FIG. 1, but shows a component of the apparatus removed for clarity (as described below), and depicts a circuit board to be cleaned received by the apparatus.

FIG. 4 is a diagrammatic cross view of a portion of the FIG. 1 apparatus in one operational orientation.

FIG. 5 is a diagrammatic end view of a portion of the FIG. 4 apparatus.

FIG. 6 is a diagrammatic cross view of a portion of the FIG. 1 apparatus in another operational orientation.

FIG. 7 is a diagrammatic end view of a portion of the FIG. 6 apparatus.

FIG. 8 is a functional block diagram of a computing system according to one embodiment.

### DETAILED DESCRIPTION OF THE PREFERRED EMBODIMENTS

16 This disclosure of the invention is submitted in furtherance of the constitutional purposes of the U.S. Patent Laws “to promote the progress of science and useful arts” (Article 1, Section 8).

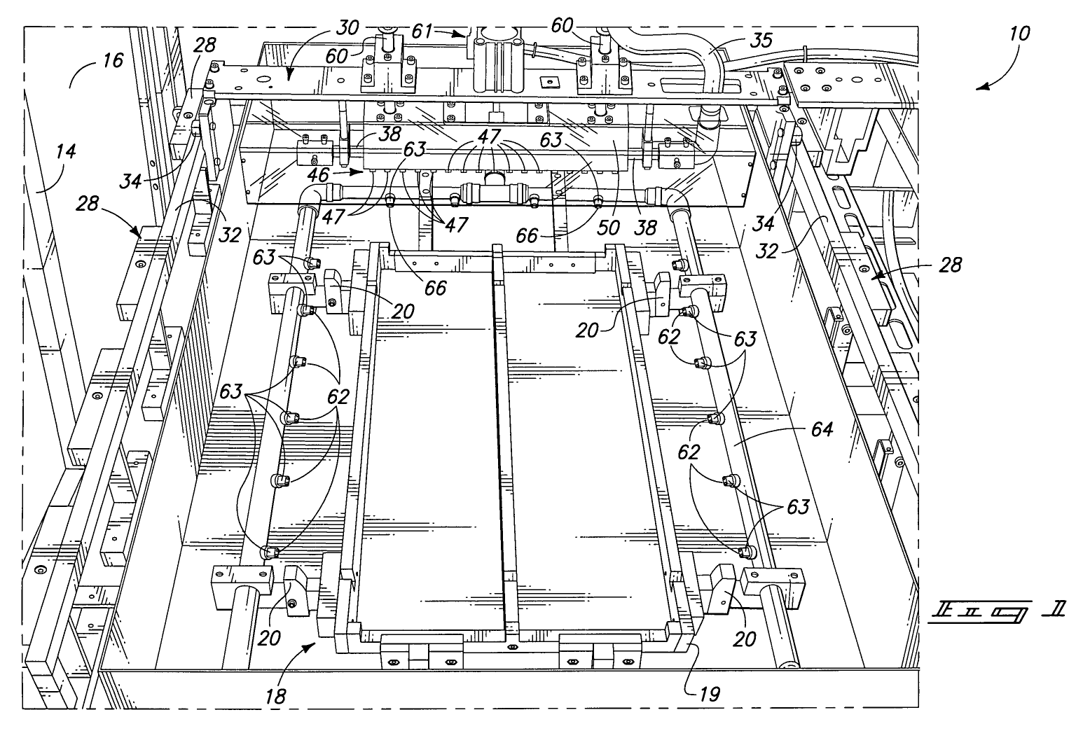

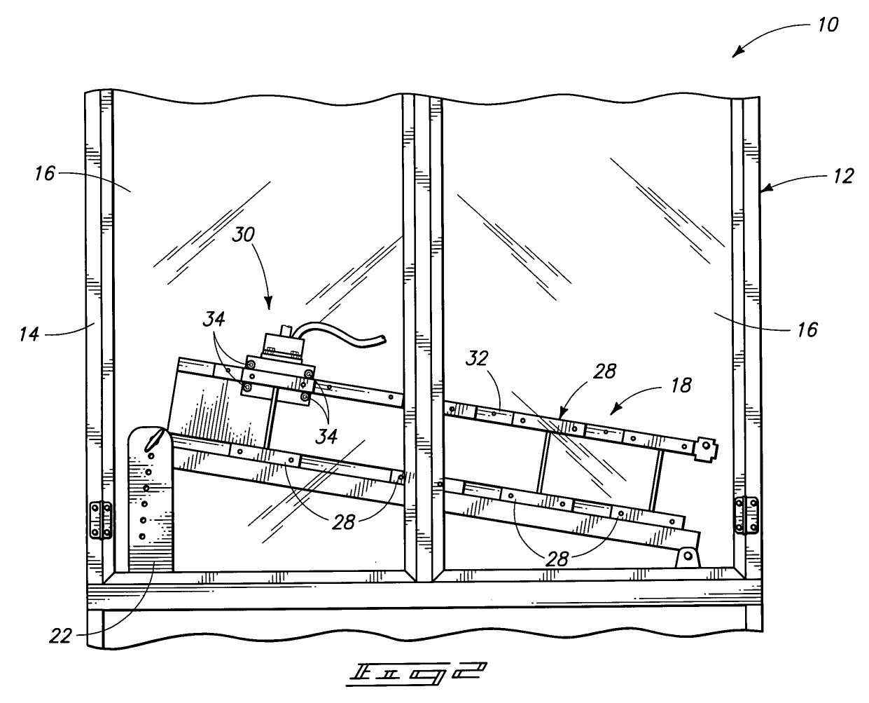

Exemplary preferred circuit board cleaning apparatus and methods of cleaning circuit boards are described with reference to FIGS. 1-8. Referring initially to FIGS. 1 and 2, a circuit board cleaning apparatus is indicated generally with reference numeral 10. In the depicted exemplary embodiment, such comprises a suitable rectangular enclosure 12 comprising a supporting structure 14 and transparent panes 16 for viewing a circuit board during processing. A circuit board support structure 18 is received within exemplary enclosure 12. Such includes an exemplary base structure 19 upon which a circuit board being cleaned rests, and circuit board guides 20 received thereabout. In a most preferred embodiment, support structure 18 is configured to receive and orient the circuit board being cleaned at an angle from horizontal and from vertical during the cleaning of such circuit board. FIG. 2 best illustrates exemplary elevating hardware 22 for selectively raising and lowering one end of the circuit board support relative to an opposing end to achieve a desired angle. An exemplary preferred angle during cleaning is from 10° to 25° from horizontal, with an angle of 10° being depicted in FIG. 2. Regardless, support structure 18 is of course exemplary only, and any circuit board support structure configured to receive a circuit board for cleaning might be used, and whether existing or yet-to-be developed.

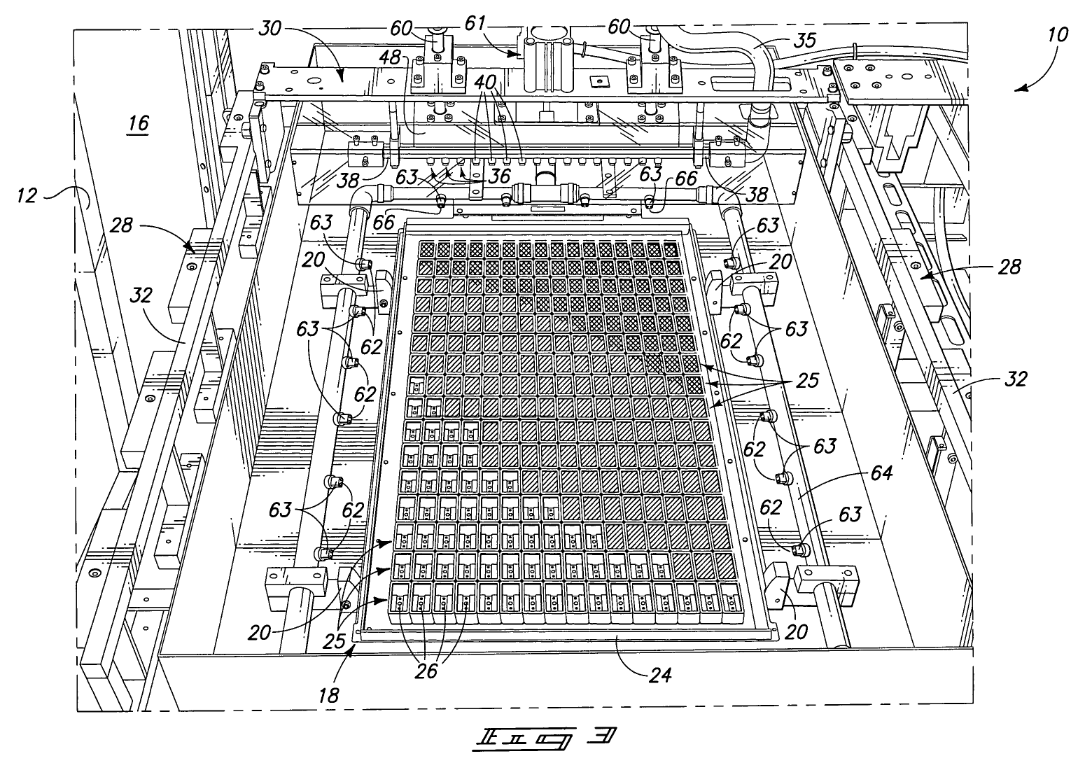

FIG. 1 depicts apparatus 10 wherein no circuit board has been inserted/received by structure 18 for cleaning, whereas FIG. 3 depicts apparatus 10 having an exemplary circuit board 24 received by support structure 18 for cleaning. In the depicted exemplary embodiment, circuit board 24 comprises a burn-in board comprising a plurality of rows 25 of sockets 26 which are individually configured to removably receive an integrated circuit package during the burn-in of said package. In one specific preferred embodiment, apparatus 10 is configured for use with depressable zero insertion force sockets of a circuit board such as a burn-in board, with sockets 26 being depicted as exemplary zero insertion force sockets. The invention, of course, contemplates an apparatus and method associated with burn-in boards having other sockets, and to circuit boards independent of whether such comprise any sockets and independent of whether a circuit board with or without sockets is utilized for burn-in. Any existing or yet-to-be developed circuit board is contemplated, with examples including printed circuit boards, printed wiring boards, burn-in boards, temperature humidity boards, etc. Further, while the specific preferred exemplary embodiment apparatus is primarily configured for use with depressable zero insertion force sockets, embodiments so configured might be used for cleaning circuit boards not having zero insertion force sockets. Further, apparatus embodiments of the invention encompass constructions which do not necessarily enable actuation or depressing of zero insertion force sockets, with the depicted preferred embodiment being so enabled as will be apparent from the continuing discussion. Further and regardless, preferred embodiment apparatus having the capability of mechanically opening certain sockets might be utilized with boards having such sockets and/or with boards not having such sockets in a manner that doesn't open any sockets.

In one implementation, a plurality of spray openings are oriented to spray cleaning fluid onto a circuit board as received by the support structure (i.e., a burn-in board received by a burn-in board support structure). Such spray openings are preferably mounted above the support structure for movement relative to the support structure across the circuit board during cleaning of the circuit board. For example and by way of example only, cleaning apparatus 10 is depicted as comprising support hardware 28 which supports a movable fluid spraying device 30 which can sweep back and forth across a circuit board 24 received by circuit support structure 18. In the depicted preferred embodiment, fluid spraying device 30 also comprises socket engagers for depressing and releasing zero insertion force sockets 26, as will be described in more detail below. Support hardware 28 includes rails 32 upon which fluid spraying device 30 can be caused to roll via exemplary rollers 34. A suitable drive mechanism, for example electric, can be computer controlled for positioning and selectively moving fluid spraying device 30 along or relative to support hardware 28 and guide rails 32.

Apparatus 10 is depicted as comprising a plurality of spray openings 36 oriented to spray cleaning fluid onto a circuit board as received by support structure 18. In a depicted preferred embodiment, spray openings 36 are formed relative to a spray bar manifold 38 which preferably provides a plenum common to the openings for spraying cleaning fluid therefrom. An exemplary cleaning fluid feed hose 35 connects with spray bar manifold 38. Further in the depicted preferred embodiment, spray openings 36 are comprised or encompassed by spray nozzles 40 which preferably removably and replaceably mount to spray bar manifold 38. An exemplary preferred cleaning fluid comprises liquid water at a temperature of at least 100° F., with a temperature of 160° F. being a specific example. An exemplary flow rate per nozzle is from 1.2 liters/minute to 2.0 liters/minute.

In the depicted exemplary embodiment, the number of sockets 26 of burn-in board 24 is the same (i.e., sixteen, as shown) in each of a plurality of rows 25, and also wherein preferably the plurality of spray openings are oriented to spray cleaning fluid onto at least one row of such sockets of the burn-in board. Further preferably, the number of openings 36 is equal to that of the number of sockets 26 in one of the plurality of rows 25 of sockets 26. Thus in one preferred embodiment, there is one spray opening per socket in a row of sockets in a burn-in board, or in some other circuit board being cleaned which has sockets. Alternately of course, fewer or more spray openings might be utilized, and not necessarily oriented specifically relative to socket orientation, and if sockets are utilized whether such are presented in specific repeating rows.

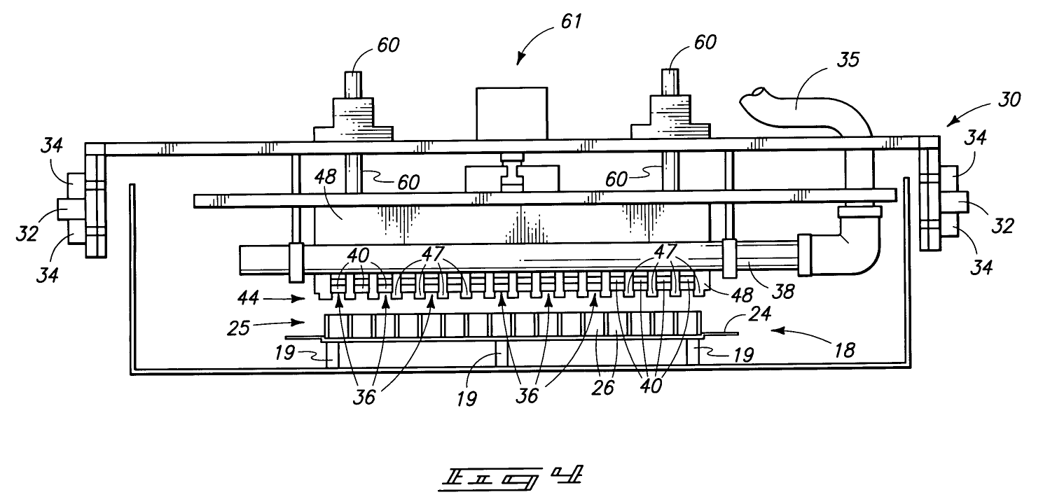

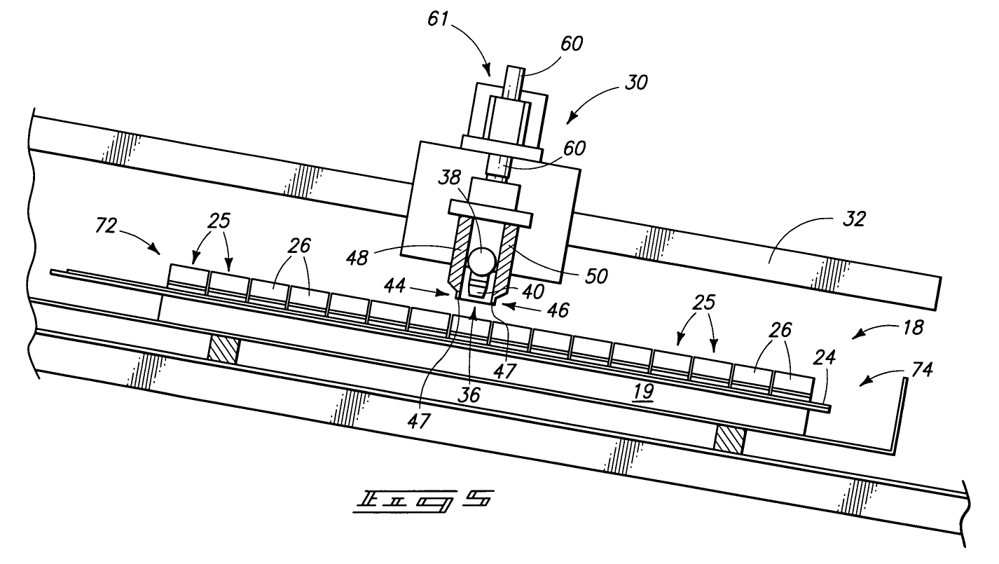

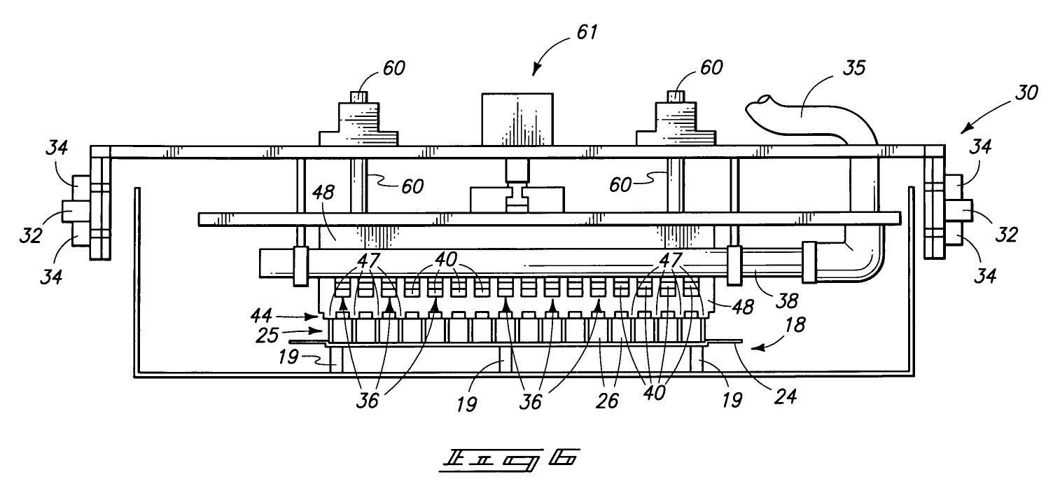

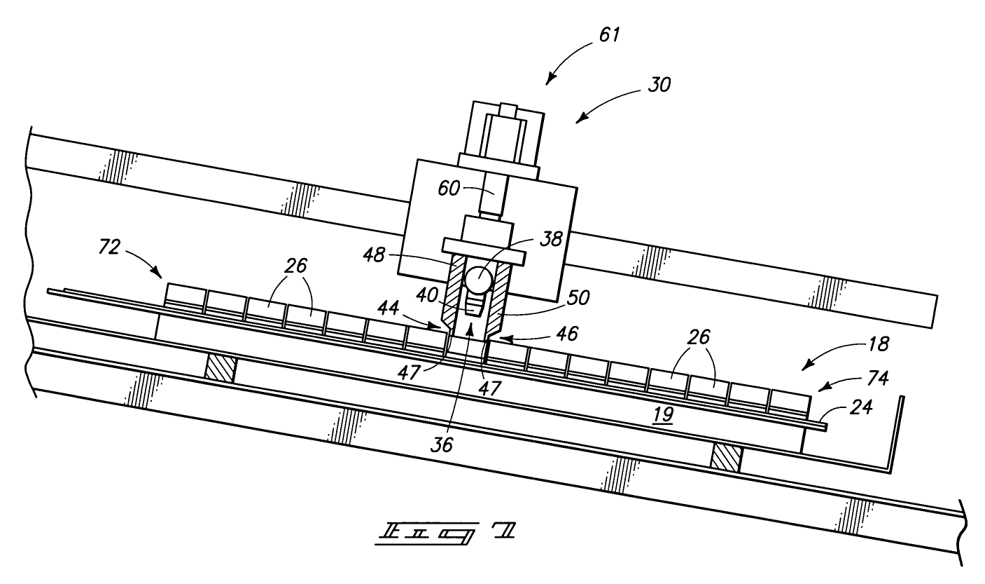

Fluid spraying device 30 of apparatus 10 is depicted as comprising two rows 44 and 46 of socket engagers 47 which are mounted for movement towards and away from a row 25 of zero insertion force sockets 26 to depress (FIGS. 6 and 7) and release (FIGS. 4 and 5) such sockets of burn-in board 24 as received by support structure 18 during cleaning of the burn-in board. In the depicted exemplary embodiment, socket engagers 47 are encompassed by two plate members 48 and 50 which are mounted for movement towards and away from a burn-in board or other circuit board received by support structure 18. (Plate 50 has been removed from apparatus 10 in FIG. 3 for clarity.) An exemplary manner by which plates 48, 50 and socket engagers 47 can be moved towards and away from the circuit board support structure includes depicted guide shafts 60 which guide movement of plates 48 and 50 which can be suitably driven, for example by an air cylinder mechanism 61 or other device.

In the depicted preferred embodiment, a plurality of spray openings 36 are received between the two rows 44, 46 of socket engagers 47, with the preferred spray bar manifold 38 thereby also being received between the two rows of socket engagers. In one preferred implementation and as shown, spray openings 36 are not mounted for movement toward or away from support structure 18 during the cleaning of a circuit board. Further in accordance with the exemplary embodiment, rows 44, 46 of socket engagers 47 are mounted for movement relative to spray openings 36 towards and away from circuit board support structure 18. Regardless, in one preferred embodiment, rows 44, 46 of socket engagers 47 and spray openings 36 therebetween are mounted above support structure 18 for movement in unison relative to support structure 18 across rows 25 of sockets 26 during the cleaning of burn-in board 24. For example, structure 30 can be moved from and between one end 72 of burn-in board 24 to an opposing end 74.

An aspect of the invention encompasses a circuit board cleaning apparatus comprising a circuit board support structure configured to receive a circuit board for cleaning. Two plate members are mounted for movement towards and away from such circuit board (perhaps independent of purpose) as received by the support structure. A plurality of spray openings are received between the two plate members and oriented to spray cleaning fluid onto such circuit board as received by the support structure. The two plate members and spray openings therebetween are mounted above the support structure for movement in unison relative to the support structure across such circuit board during cleaning of the circuit board. The above described and depicted embodiment is only but one example configuration of such an apparatus.

Preferred embodiment cleaning apparatus 10 is also depicted as comprising side spray openings 62 which are oriented to spray cleaning fluid onto a circuit board as received by support structure 18 from the opposing sides or edges of circuit board 24. Such are depicted in the preferred embodiment as encompassing nozzles 63 which removable and replaceably mount relative to a U-shaped spray bar manifold 64 received about circuit board support structure 18. Spray manifold 64 is also depicted as comprising end spray openings 66 oriented to spray cleaning fluid onto a circuit board as received by support structure 18 from an end of such circuit board. Such are also depicted as comprising, in a preferred embodiment, removably mounted nozzles 63. By way of example only, nozzles 63 might be oriented to spray predominantly onto the side edges of a circuit board during cleaning, predominantly onto the back or underside of the board, a combination of both, etc.

Exemplary methods of employing the above-described preferred embodiment apparatus used in cleaning a circuit board are described below. However, methodical aspects of the invention as disclosed and claimed can be practiced in accordance with the invention independent of the preferred embodiment apparatus or other apparatus. In other words, the method claims are not limited by apparatus, nor are the apparatus claims limited by method, unless specific attributes are literally claimed in the respective method and apparatus claims.

First described is but one preferred method of cleaning a burn-in board comprising a plurality of rows of zero insertion force sockets individually configured to removably receive an integrated circuit package during the burn-in of said package. For example and by way of example only in the depicted embodiment, burn-in board 24 can be considered as comprising an exemplary first end 72 and an exemplary second end 74. Zero insertion force sockets 26 are preferably at some point depressed along one of rows 25 of such sockets, for example in the manner depicted in FIGS. 6 and 7. Preferably, such depressing in a cleaning method in accordance with one aspect of the invention starts with the first row 25 of zero insertion force sockets 26 most proximate first end 72. While the sockets of such row are depressed, cleaning fluid is sprayed from the plurality of spray openings 36 into the one row 25 of depressed sockets 26. Subsequently, such one row of depressed sockets are released from being depressed, and the spray openings moved to a stopped position over the next adjacent of rows 25 of zero insertion force sockets 26. While spray openings 36 are in a stopped position over such next adjacent row 25 of zero insertion force sockets 26, the zero insertion force sockets in such next adjacent row are depressed, for example by socket engagers 47. While such sockets are depressed, cleaning fluid is sprayed from the spray openings into such next adjacent row of sockets while the openings are in such stopped position. Subsequently, the sockets of such next adjacent row are released from being depressed. Such actions are then repeated with the other rows until all of the rows of zero insertion force sockets have been sprayed with cleaning fluid. An exemplary preferred residence time of the spray openings over depressed sockets is from 1 second to 10 seconds.

In such exemplary preferred method, the burn-in board is preferably angled from vertical and horizontal during all of the stated actions, with the preferred angle being as in accordance with the above-described apparatus embodiment of from 10° to 25° from horizontal. The preferred cleaning fluid comprises liquid water (i.e., de-ionized or reverse osmosis filtered water) at a preferred temperature of at least 100° F., with 160° F. being a specific example. In one preferred embodiment, the cleaning fluid continuously sprays from the spray openings during all of the above actions of depressing the sockets, releasing the sockets from being depressing, and moving the spray openings from row to row. Further, methodical aspects of such preferred embodiment method also encompass spraying cleaning fluid onto the burn-in board from a stationary set of spray openings while spraying fluid from the spray openings which move between the rows of sockets. For example and by way of example only, such spraying from a stationary set of spray openings might be conducted from openings 62 of the above apparatus embodiment, or from other openings. Further in one preferred embodiment, depressing of exemplary spring-loaded zero insertion force sockets preferably occurs in accordance with the operation of the above-described or other apparatus wherein the depressing comprises moving two rows of sockets engagers to engage the row of zero insertion force sockets being depressed, and further preferably wherein the spray openings are received between such two rows of socket engagers.

Another preferred implementation of a method of cleaning a circuit board in accordance with the invention comprises positioning a circuit board at an angle from horizontal and vertical. The preferred angle is from 10° to 25° from horizontal. Cleaning fluid is sprayed onto a side of the circuit board from a plurality of spray openings while moving the spray openings across the side of the circuit board. Such moving might be in a start-and-stop stepped manner, might be continuous, or include a combination of some start-and-stop stepped and continuous movings. For example and by way of example only, the moving might comprise at least two passes of the spray openings from a first end of a circuit board to a second end of a circuit board wherein in one of the passes the moving is in a start-and-stop stepped manner, and which in another of the at least two passes the moving is continuous. An exemplary preferred cleaning fluid again is liquid water at a preferred temperature of at least 100° F. Further in one preferred embodiment, the cleaning fluid is continuously sprayed from the spray openings during the moving of the plurality of spray openings. A preferred aspect of this embodiment method also might include spraying cleaning fluid onto the circuit board from a stationary set of spray openings while spraying fluid from the spray openings which move across the side of the circuit board.

Yet another implementation of an aspect of the invention encompasses a method of cleaning a circuit board that comprises spraying cleaning fluid onto a side of a circuit board from a plurality of spray openings while moving the spray openings across the side of the circuit board from a first end of the circuit board to a second end of the circuit board in a start-and-stop stepped manner. In one implementation, the cleaning fluid comprises liquid water at a temperature of at least 100° F. and might be continuously or intermittently sprayed from the spray openings during the moving of the spray openings. The cleaning might also comprise at least two passes of the spray openings from the first end to the second end wherein during at least one of the two passes, the moving is in the stated start-and-stop stepped manner, and in another of the at least two passes is continuous.

In one implementation, a method of cleaning a circuit board sequentially comprises spraying cleaning fluid onto a side of a circuit board from a plurality of spray openings while continuously moving the spray openings across the side of the circuit board from a first end of the circuit board to a second end of the circuit board. The spray openings are then moved to the first end of the circuit board. Cleaning fluid is then sprayed onto the side of the circuit board from the spray openings while moving the spray openings across the side of the circuit board from the first end to the second end in and start-and-stop stepped manner. Then, the spray openings are moved to the first end of the circuit board, and cleaning fluid is sprayed onto the side of the circuit board from the spray openings while continuously moving the spray openings across the side of the circuit board from the first end to the second end. As above, the circuit board is preferably angled from vertical and horizontal during all of the spraying and moving, with an angle from 10° to 25° from horizontal being a preferred example. A preferred exemplary cleaning is liquid water at a temperature of at least 100° F. and regardless, the cleaning fluid might continuously or intermittently spray from the spray openings during the spraying and moving of such openings. Further in such implementation, cleaning fluid might be sprayed onto the circuit board from a stationary set of spray openings while spraying cleaning fluid from the spray openings that move from the first end to the second end of the circuit board.

In accordance with one implementation, the invention contemplates a method of cleaning a burn-in board comprising a plurality of rows of sockets individually configured to removably receive an integrated circuit package during burn-in of said package. Such method sequentially comprises spraying cleaning fluid from a plurality of spray openings into one of the rows of sockets. The spray openings are moved to a stopped position over a next adjacent of the rows of sockets, and cleaning fluid is sprayed while in such stopped position from the spray openings into such next adjacent row of sockets. Such moving and stopped position spraying are repeated until all of the rows of sockets have been sprayed with cleaning fluid. Other methodical attributes are preferably as described above.

Yet another exemplary preferred implementation of an aspect of the invention encompasses a method of cleaning a burn-in board comprising a plurality of rows of sockets individually configured to removably receive an integrated circuit package during burn-in of such package. Such method sequentially comprises spraying cleaning fluid from a line of spray openings into the rows of sockets while continuously moving the line of spray openings across the burn-in board from a first end of the burn-in board to a second end of the burn-in board. Then, the line of spray openings is moved to the first end of the burn-in board. Cleaning fluid is sprayed into individual rows of the sockets while moving the line of spray openings from the first end of the burn-in board to the second end of the burn-in board in a start-and-stop stepped manner over the individual rows of sockets. Then, the line of spray openings is moved to the first end of the burn-in board, and cleaning fluid is sprayed from the line of spray openings into the rows of sockets while continuously moving the line of spray openings across the burn-in board from the first end to the second end. Other preferred methodical attributes are preferably as described above.

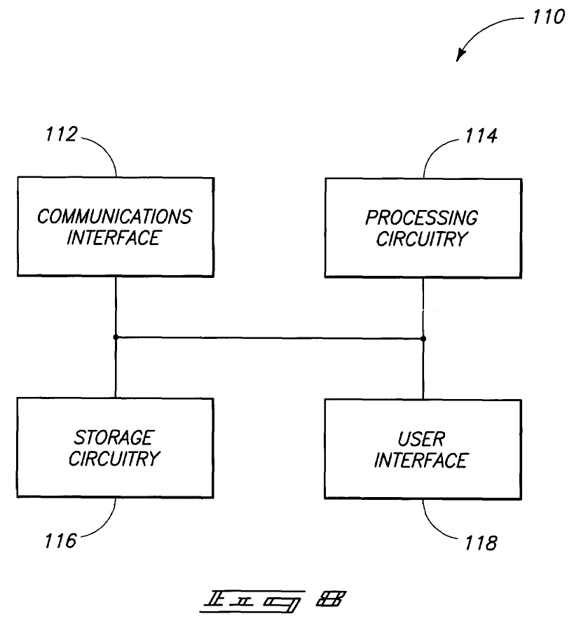

Apparatus and/or method aspects of the invention might include or be controlled by a computing system, for example a system 110 of FIG. 8. Computing system 110 may be configured to implement methodical and/or apparatus aspects of the disclosure.

Computing system 110 may be implemented in exemplary embodiments using any appropriate processing device, such as a personal computer, workstation, server, etc. The exemplary depicted computing system 110 includes a communications interface 112, processing circuitry 114, storage circuitry 116 and a user interface 118 according to one embodiment. Other embodiments are possible including more, less and/or alternative structure. Further, additional computing systems 110 may be utilized in other embodiments.

Communications interface 112 is arranged to implement communications of computing system 110 with respect to external devices (not shown). For example, communications interface 112 may be arranged to communicate information bi-directionally with respect to computing system 110. Communications interface 112 may be implemented as a network interface card (NIC), serial or parallel connection, USB port, Firewire interface, flash memory interface, floppy disk drive, or any other suitable arrangement for communicating with respect to computing system 110.

In one embodiment, processing circuitry 114 is arranged to process data, control data access and storage, issue commands, and control other desired operations. Processing circuitry 114 may comprise circuitry configured to implement desired programming provided by appropriate media in at least one embodiment. For example, the processing circuitry 114 may be implemented as one or more of a processor and/or other structure configured to execute executable instructions including, for example, software and/or firmware instructions, and/or hardware circuitry. Exemplary embodiments of processing circuitry 114 include hardware logic, PGA, FPGA, ASIC, state machines, and/or other structures alone or in combination with a processor. These examples of processing circuitry 114 are for illustration and other configurations are possible.

The storage circuitry 116 is configured to store programming such as executable code or instructions (e.g., software and/or firmware), electronic data, databases, and/or other digital information and may include processor-usable media. Processor-usable media may be embodied in any computer program product or article of manufacture which can contain, store, or maintain programming, data and/or digital information for use by or in connection with an instruction execution system including processing circuitry 114 in the exemplary embodiment. For example, exemplary processor-usable media may include any one of physical media such as electronic, magnetic, optical, electromagnetic, infrared or semiconductor media. Some more specific examples of processor-usable media include, but are not limited to, a portable magnetic computer diskette, such as a floppy diskette, zip disk, hard drive, random access memory, read only memory, flash memory, cache memory, and/or other configurations capable of storing programming, data, or other digital information.

At least some embodiments or aspects described herein may be implemented using programming stored within appropriate storage circuitry 116 described above and/or communicated via a network or other transmission media and configured to control appropriate processing circuitry. For example, programming may be provided via appropriate media including for example embodied within articles of manufacture, embodied within a data signal (e.g., modulated carrier wave, data packets digital representations, etc.) communicated via an appropriate transmission medium, such as a communication network (e.g., the Internet and/or a private network), wired electrical connection, optical connection and/or electromagnetic energy, for example, via a communications interface, or provided using other appropriate communication structure or medium. Exemplary programming including processor-usable code may be communicated as a data signal embodied in a carrier wave in but one example.

User interface 118 is configured to interact with a user including conveying data to a user (e.g., displaying data for observation by the user, audibly communicating data to a user, etc.) as well as receiving inputs from the user (e.g., tactile input, voice instruction, etc.). Accordingly, in one exemplary embodiment, the user interface 118 may include a display (e.g., cathode ray tube, LCD, etc.) configured to depict visual information and an audio system as well as a keyboard, mouse and/or other input device. Any other suitable apparatus for interacting with a user may also be utilized.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

1. A circuit board cleaning apparatus, comprising:
a circuit board support structure configured to receive a circuit board for cleaning; and
a plurality of spray openings oriented to spray cleaning fluid onto said circuit board as received by the support structure, the spray openings being mounted above the support structure for movement relative to the support structure across said circuit board during cleaning of said circuit board.

2. The apparatus of claim 1 comprising a spray bar manifold, the spray openings being received by the spray bar manifold.

3. The apparatus of claim 1 comprising a spray bar manifold, the spray openings comprising spray nozzles mounted to the spray bar manifold.

4. The apparatus of claim 1 comprising side spray openings oriented to spray cleaning fluid onto said circuit board as received by the support structure from opposing sides of said circuit board.

5. The apparatus of claim 4 comprising a spray bar manifold, the side spray openings being received by the spray bar manifold.

6. The apparatus of claim 4 comprising end spray openings oriented to spray cleaning fluid onto said circuit board as received by the support structure from an end of said circuit board.

7. The apparatus of claim 1 wherein the spray openings are not mounted for movement toward or away from the support structure during cleaning of said circuit board.

8. A circuit board cleaning apparatus, comprising:
a circuit board support structure configured to receive a circuit board for cleaning, the support structure being configured to receive and orient the circuit board being cleaned at an angle from horizontal and from vertical during cleaning of said circuit board; and
a plurality of spray openings oriented to spray cleaning fluid onto said circuit board as received by the support structure, the spray openings being mounted above the support structure for movement relative to the support structure across said circuit board during cleaning of said circuit board.

9. The apparatus of claim 8 wherein the angle is from 10 degrees to 25 degrees from horizontal.

10. A circuit board cleaning apparatus, comprising:
a circuit board support structure configured to receive a circuit board for cleaning;
two plate members mounted for movement towards and away from said circuit board as received by the support structure;
a plurality of spray openings received between the two plate members and oriented to spray cleaning fluid onto said circuit board as received by the support structure; and
the two plate members and spray openings therebetween being mounted above the support structure for movement in unison relative to the support structure across said circuit board during cleaning of said circuit board.

11. The apparatus of claim 10 wherein the support structure is configured to receive and orient the circuit board being cleaned at an angle from horizontal and from vertical during cleaning of said circuit board.

12. The apparatus of claim 11 wherein the angle is from 10 degrees to 25 degrees from horizontal.

13. The apparatus of claim 10 wherein the two plate members are mounted for movement relative to the spray openings towards and away from said circuit board as received by the support structure.

14. The apparatus of claim 10 wherein the spray openings are not mounted for movement toward or away from the support structure during cleaning of said circuit board.

15. The apparatus of claim 10 wherein the two plate members are mounted for movement relative to the spray openings towards and away from said circuit board as received by the support structure, and the spray openings are not mounted for movement toward or away from the support structure during cleaning of said circuit board.

16. A burn-in board cleaning apparatus, comprising:
a burn-in board support structure configured to receive a burn-in board for cleaning, said burn-in board comprising a plurality of rows of sockets individually configured to removably receive an integrated circuit package during burn-in of said package; and
a plurality of spray openings oriented to spray cleaning fluid onto at least one row of said sockets of said burn-in board as received by the support structure during cleaning of said burn-in board, the spray openings being mounted above the support structure for movement relative to the support structure across the rows of said sockets during cleaning of said burn-in board.

17. The apparatus of claim 16 wherein the number of said sockets is the same in each of said plurality of rows of sockets of said burn-in board, the plurality of spray openings being oriented in at least one row having an equal number of spray openings to that of said number of sockets in one of the plurality of rows of sockets.

18. The apparatus of claim 16 wherein the support structure is configured to receive and orient the burn-in board being cleaned at an angle from horizontal and from vertical during cleaning of said burn-in board.

19. The apparatus of claim 18 wherein the angle is from 10 degrees to 25 degrees from horizontal.

20. The apparatus of claim 16 comprising a spray bar manifold, the spray openings being received by the spray bar manifold.

21. The apparatus of claim 16 comprising a spray bar manifold, the spray openings comprising spray nozzles mounted to the spray bar manifold.

22. The apparatus of claim 16 comprising side spray openings oriented to spray cleaning fluid onto said burn-in board as received by the support structure from opposing sides of said burn-in board.

23. The apparatus of claim 22 comprising a spray bar manifold, the side spray openings being received by the spray bar manifold.

24. The apparatus of claim 22 comprising end spray openings oriented to spray cleaning fluid onto said burn-in board as received by the support structure from an end of said burn-in board.

25. The apparatus of claim 16 wherein the spray openings are not mounted for movement toward or away from the support structure during cleaning of said burn-in board.

26. A burn-in board cleaning apparatus, comprising:
a burn-in board support structure configured to receive a burn-in board for cleaning, said burn-in board comprising a plurality of rows of zero insertion force sockets individually configured to removably receive an integrated circuit package during burn-in;
two rows of socket engagers mounted for movement towards and away from a row of said zero insertion force sockets to depress and release said sockets of said burn-in board as received by the support structure during cleaning of said burn-in board;
a plurality of spray openings received between the two rows of socket engagers and oriented to spray cleaning fluid onto said row of said zero insertion force sockets of said burn-in board as received by the support structure during cleaning of said burn-in board; and
the two rows of socket engagers and spray openings therebetween being mounted above the support structure for movement in unison relative to the support structure across the rows of said sockets during cleaning of said burn-in board.

27-30. (canceled)

31. A burn-in board cleaning apparatus, comprising:
a burn-in board support structure configured to receive a burn-in board for cleaning, said burn-in board comprising a plurality of rows of zero insertion force sockets individually configured to removably receive an integrated circuit package during burn-in, the support structure being configured to receive and orient the burn-in board being cleaned at an angle from horizontal and from vertical during cleaning of said burn-in board;
two plate members mounted for movement towards and away from a row of said zero insertion force sockets to depress and release said sockets of said burn-in board as received by the support structure during cleaning of said burn-in board;
a spray bar manifold received between the two plate members, the spray bar manifold comprising a plurality of spray openings oriented to spray cleaning fluid onto said row of said zero insertion force sockets of said burn-in board as received by the support structure during cleaning of said burn-in board, the two plate members being mounted for movement relative to the spray bar manifold towards and away from said row of said zero insertion force sockets of said burn-in board as received by the support structure during cleaning of said burn-in board;
and the two plate members and spray bar manifold therebetween being mounted above the support structure for movement in unison relative to the support structure across the rows of said sockets during cleaning of said burn-in board.

32-36. (canceled)

37. A method of cleaning a circuit board, comprising:
positioning a circuit board at an angle from horizontal and vertical; and
spraying cleaning fluid onto a side of the circuit board from a plurality of spray openings while moving the spray openings across the side of the circuit board.

38-44. (canceled)

45. A method of cleaning a circuit board comprising spraying cleaning fluid onto a side of a circuit board from a plurality of spray openings while moving the spray openings across the side of the circuit board from a first end of the circuit board to a second end of the circuit board in a start and stop stepped manner.

46-47. (canceled)

48. A method of cleaning a circuit board sequentially comprising:
spraying cleaning fluid onto a side of a circuit board from a plurality of spray openings while continuously moving the spray openings across the side of the circuit board from a first end of the circuit board to a second end of the circuit board;
moving the spray openings to the first end of the circuit board;
spraying cleaning fluid onto the side of the circuit board from the spray openings while moving the spray openings across the side of the circuit board from the first end to the second end in a start and stop stepped manner;
moving the spray openings to the first end of the circuit board; and
spraying cleaning fluid onto the side of a circuit board from the spray openings while continuously moving the spray openings across the side of the circuit board from the first end to the second end.

49-50. (canceled)

51. A method of cleaning a burn-in board comprising a plurality of rows of sockets individually configured to removably receive an integrated circuit package during burn-in of said package, the method sequentially comprising:
spraying cleaning fluid from a plurality of spray openings into one of the rows of sockets;
moving the spray openings to a stopped position over a next adjacent of the rows of sockets, and spraying cleaning fluid while in said stopped position from the spray openings into said next adjacent row of sockets; and
repeating said moving and stopped position spraying until all of the rows of sockets have been sprayed with cleaning fluid.

52-53. (canceled)

54. A method of cleaning a burn-in board comprising a plurality of rows of sockets individually configured to removably receive an integrated circuit package during burn-in of said package, the method sequentially comprising:
spraying cleaning fluid from a line of spray openings into the rows of sockets while continuously moving the line of spray openings across the burn-in board from a first end of the burn-in board to a second end of the burn-in board;
moving the line of spray openings to the first end of the burn-in board;
spraying cleaning fluid into individual rows of the sockets while moving the line of spray openings from the first end of the burn-in board to the second end of the burn-in board in a start and stop stepped manner over said individual rows of the sockets;
moving the line of spray openings to the first end of the burn-in board: and
spraying cleaning fluid from the line of spray openings into the rows of sockets while continuously moving the line of spray openings across the burn-in board from the first end to the second end.

55-56. (canceled)

57. A method of cleaning a burn-in board comprising a plurality of rows of zero insertion force sockets individually configured to removably receive an integrated circuit package during burn-in of said package, the method sequentially comprising:
depressing the zero insertion force sockets along one of the rows of said sockets;
while the sockets of the one row are depressed, spraying cleaning fluid from a plurality of spray openings into said one row of depressed sockets;
releasing the one row of depressed sockets from being depressed;
moving the spray openings to a stopped position over a next adjacent of the rows of zero insertion force sockets:
while the spray openings are in said stopped position over said next adjacent of the rows of zero insertion force sockets, depressing said zero insertion force sockets of said next adjacent row of sockets;
while the sockets of said next adjacent row are depressed, spraying cleaning fluid while in said stopped position from the spray openings into said next adjacent row of sockets;
releasing said next adjacent row of depressed sockets from being depressed; and
repeating said moving, depressing, stopped position spraying, and releasing of next adjacent rows of zero insertion force sockets until all of the rows of the zero insertion force sockets have been sprayed with cleaning fluid.

58-63. (canceled)
